(19) United States
(12) Patent Application Publication
(10) Pub. No.: US 2026/0118497 A1
(43) Pub. Date: Apr. 30, 2026

(54) Doppler Velocity Recovery and Dealiasing Algorithm for Multi-PRT Scans in Weather Radars

(71) Applicant: The Board of Regents of the University of Oklahoma, Norman, OK (US)

(72) Inventors: David Schvartzman, Norman, OK (US); Robert D. Palmer, Norman, OK (US)

(21) Appl. No.: 19/480,230

(22) PCT Filed: Apr. 14, 2025
(86) PCT No.: PCT/US2025/024498

§ 371 Date: Oct. 30, 2025

Related U.S. Application Data
(60) Provisional application No. 63/633,523, filed on Apr. 12, 2024.
(60) Provisional application No. 63/636,003, filed on Apr. 18, 2024.

(51) Int. Cl. G01S 13/58; G01S 13/89; G01S 13/95

(52) U.S. Cl. CPC G01S 13/581; G01S 13/89; G01S 13/951

(57) ABSTRACT

A method comprises: obtaining data from a radar, wherein the data comprise CD velocity data and CS velocity data, wherein the CD velocity data comprise RF velocity data and non-aliased velocity data, and wherein the CS velocity data are aliased and spatially correspond to regions with the RF velocity data; determining a boundary between the RF velocity data and the non-aliased velocity data in an initial CD map; replacing the RF velocity data with the CS velocity data in the initial CD map to obtain a modified CD map; and performing a velocity recovery on at least some of the CS velocity data along the boundary to obtain a dealiased map.

### CROSS-REFERENCE TO RELATED APPLICATIONS

This claims priority to U.S. Prov. Patent App. No. 63/633,523 filed on Apr. 12, 2024 and U.S. Prov. Patent App. No. 63/636,003 filed on Apr. 18, 2024, both of which are incorporated by reference.

### STATEMENT REGARDING FEDERALLY SPONSORED RESEARCH OR DEVELOPMENT

Not applicable.

### BACKGROUND

Pulsed-Doppler radars are susceptible to range-velocity ambiguities inherent from using a uniform train of electromagnetic pulses to sample the atmosphere. Ambiguities arise due to the well-known Doppler dilemma, where increasing the PRT increases the maximum unambiguous range but decreases the maximum unambiguous velocity and vice versa. Demands on any of the techniques to simultaneously mitigate these range-and-velocity ambiguities increase to a point of breakdown when they are needed most, that is, in the presence of widespread outbreaks of severe weather with convective storm over large areas.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a graph showing Doppler velocities that would be measured with typical CS and CD scan parameters.

FIGS. 2A and 2B are graphs demonstrating the median filter dealiasing concept.

FIGS. 3A and 3B are graphs showing the conceptual depiction of the velocity recovery technique.

FIG. 4 is a flowchart of the VRAD algorithm.

FIGS. 5A-5D are graphs showing processed fields of radar data.

FIGS. 6A-6C are graphs that are the same case as the graphs in FIGS. 5A, 5B, and 5D, but zoomed into the RF region east of the radar.

FIGS. 7A-7D are graphs of processed fields of radar data from Hurricane Harvey.

FIGS. 8A-8C are graphs that are the same case as the graphs in FIGS. 7A, 7B, and 7D, but zoomed into the RF region east of the radar.

FIGS. 9A-9D are graphs of processed fields of radar data the severe weather outbreak that devastated the North-East United States in August 2023.

FIGS. 10A-10C are graphs that are the same case as the graphs in FIGS. 9A, 9B, and 9D, but zoomed into the RF region east of the radar.

FIG. 11 is a table providing a VRAD algorithm performance summary.

FIG. 12 is a flowchart illustrating a method of VRAD.

FIG. 13 is a schematic diagram of an apparatus.

### DETAILED DESCRIPTION

Before describing various embodiments of the present disclosure in more detail by way of exemplary description, examples, and results, it is to be understood that the present disclosure is not limited in application to the details of methods and compositions as set forth in the following description. The present disclosure is capable of other embodiments or of being practiced or carried out in various ways. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, provisional applications, published patent applications, and non-patent publications referenced in any portion of this application, including but not limited to U.S. Provisional Application Ser. No. 63/496,600, filed on Apr. 17, 2023, are herein expressly incorporated by reference in their entirety to the same extent as if each individual patent or publication was specifically and individually indicated to be incorporated by reference.

As utilized in accordance with the methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z. The term “plurality” generally refers to two or more items. Unless otherwise required by context, singular terms shall include pluralities and plural terms shall include the singular. Where used herein, the specific term “single” is limited to only “one,” and a “pair” means two.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example. Thus a reference to degrees such as 1 to 90 is intended to explicitly include all degrees in the range.

As noted above, any numerical range listed or described herein is intended to include, implicitly or explicitly, any number or sub-range within the range, particularly all integers, including the end points, and is to be considered as having been so stated. For example, “a range from 1.0 to 10.0” is to be read as indicating each possible number, including integers and fractions, along the continuum between and including 1.0 and 10.0, that is, having a minimum value equal to or greater than 1.0 and a maximum value equal to or less than 10.0, such as, for example, 3.25 to 8.65. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. Thus, even if a particular data point within the range is not explicitly identified or specifically referred to, it is to be understood that any data points within the range are to be considered to have been specified, and that the inventor(s) possessed knowledge of the entire range and the points within the range.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes an inherent variation. As used herein the qualifiers “about” or “approximately” are intended to include not only the exact value, amount, degree, dimension, measurement, orientation, event, circumstance, parameter, or other qualified characteristic, but are intended to include some slight variations due to measuring error, manufacturing tolerances, observer error, and combinations thereof, for example. The term “about” or “approximately”, where used herein when referring to a measurable value such as an amount, a temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described value, amount, degree, dimension, measurement, orientation, event, circumstance or parameter, or other qualified characteristic completely occurs, or occurs to a great extent or degree. For example, the term “substantially” means that the subsequently described value, amount, degree, dimension, measurement, orientation, event, circumstance, or parameter or other qualified characteristic occurs at least 80% of the time, at least 90% of the time, at least 91% of the time, at least 92% of the time, at least 93% of the time, at least 94% of the time, at least 95% of the time, at least 96% of the time, at least 97% of the time, at least 98% of the time, or at least 99% of the time.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein any reference to “we” as a pronoun herein refers generally to laboratory personnel or other contributors who assisted in the laboratory procedures and data collection and is not intended to represent an inventorship role by said laboratory personnel or other contributors in any subject matter disclosed herein.

The following abbreviations apply:
ASIC: application-specific integrated circuit
CPU: central processing unit
CD: continuous Doppler
CS: continuous surveillance
DSP: digital signal processor
EF: Enhanced Fujita
EO: electrical-to-optical
FPGA: field-programmable gate array
IQ: in-phase and quadrature
km: kilometer(s)
m: meter(s)
ms: millisecond(s)
NEXRAD: Next-Generation Radar
NWS: National Weather Service
OE: optical-to-electrical
OFCM: Office of the Federal Coordinator for Meteorology
PRT: pulse repetition time
RAM: random-access memory
RF: radio frequency, range-folded
ROM: read-only memory
RPG: radar product generator
RX: receiver unit
s: second(s)
SNR: signal-to-noise ratio
SPRT: staggered PRT
SRAM: static RAM
SZ-2: Sachidananda and Zrnić-2
TCAM: ternary content-addressable memory
TX: transmitter unit
US: United States
UTC: Coordinated Universal Time
VCP: volume coverage pattern
VRAD: velocity recovery and dealiasing
WSR-88D: Weather Surveillance Radar-1988 Doppler
1D: one-dimensional
2DVDA: two-dimensional velocity dealiasing.

Disclosed herein are embodiments for a Doppler velocity recovery and dealiasing algorithm for multi-PRT scans in weather radars. The disclosed algorithm increases the region of valid Doppler velocities recovered when multi-PRT scans (e.g., split cuts or batch scans) are used. The algorithm blends data from different scans and uses dealiasing techniques to mitigate regions with obscured velocity estimates. Data from the operational WSR-88D network are used to demonstrate the algorithm, and results are very promising. On average, the algorithm is able to increase valid velocity estimates by 25.67% in non-phase-coded scans and 12.42% in phase-coded scans.

### I. INTRODUCTION

The NEXRAD program plays a pivotal role in supporting the mission of the US NWS, offering a crucial tool: the WSR-88D. The scan strategies employed by the WSR-88D in precipitation mode, known as VCP, include the implementation of “split cuts” and phase coded waveforms at low elevations. These techniques effectively address range-and-velocity ambiguities, as outlined by the OFCM. The challenge in simultaneously resolving range and velocity ambiguities arises due to the coupling between the maximum unambiguous range (Rₐ) and the maximum unambiguous velocity (vₐ) defined as:

$${R}_{a} = \frac{{cT}_{s}}{2} and {v}_{a} = \frac{λ}{4 {T}_{S}} , \qquad ( 1 )$$

where Tₛ is the PRT, λ is the radar wavelength, and c is the speed of light. Multiplying the expressions in (1) results in the “Doppler Dilemma”:

$${R}_{a} {v}_{a} = \frac{c λ}{8} , \qquad ( 2 )$$

which shows the coupling between Rₐ and vₐ. Since c is a constant and λ is usually a fixed parameter in a radar system, there is no direct way to simultaneously get high unambiguous range and velocity measurements. Moreover, demands on any of the mitigating techniques increase to a point of breakdown when they are needed most, that is, in widespread outbreaks of severe weather, with substantial ambiguities in range and velocity of weather returns.

In split cuts, a specific elevation angle is scanned twice, utilizing two different PRTs and resulting in two 360° azimuthal rotations of the antenna at the same elevation angle. During the first half, referred to as the CS scan, a long PRT enhances spatial coverage without range ambiguities. In contrast, the second half, known as the CD scan, employs a short PRT, which can be phase coded or not, to minimize the occurrence of velocity aliasing, increasing vₐ at the expense of a shorter Rₐ. This approach enhances the accuracy and effectiveness of weather surveillance. Split cut scans are used in the lower elevation scans of most operational VCPs to mitigate range-velocity ambiguities. A subset of the higher elevation angles is scanned using a “batch PRT” mode, whereby a short sequence of uniform long PRT pulses is followed by a long sequence of short PRT pulses. And similar to the split-cut scans, data from the long PRT portion of the batch-scan dwells is used for long-range surveillance and data from the short PRT portion of the batch-scan dwells is used for better unambiguous Doppler velocity measurements.

Operationally, reflectivity (Zₕ), differential reflectivity (Z_{DR}), differential phase (Φ_{DP}), and co-polar correlation coefficient (ρₕᵥ) are obtained from the CS scan, whereas Doppler velocity (vᵣ) and spectrum width (σᵥ) are obtained from the CD scan using a “range unfolding” technique that relies on the reflectivity from the CS scan. While not currently used operationally, Doppler velocity estimates from the CS scan could be used to significantly extend the region where valid velocity estimates from the CD scan are available. Furthermore, the CS-derived velocities could be used to dealias velocities exceeding vₐ in the CD scan. The hybrid scan estimators capitalize on having these back-to-back scans with different radar data acquisition parameters to improve polarimetric radar measurements.

The algorithm seamlessly integrates CS and CD data, thereby enhancing Doppler velocity estimates. The algorithm delivers improvements through two key mechanisms. Firstly, in areas exhibiting valid CD estimates that are subject to aliasing (i.e., high velocities surpassing the Nyquist interval), the algorithm employs CS data to ascertain the folding ratio in CD velocities, facilitating accurate unfolding and the recovery of appropriately dealiased Doppler velocity estimates. Secondly, the algorithm addresses the challenge of obscured velocities, a common occurrence in WSR-88D data where estimates are often obscured, especially on range gates featuring multiple overlaid velocity estimates. In such instances, the algorithm leverages CS scan velocities to populate the otherwise inaccessible or obscured velocity regions, enhancing data completeness and accuracy. This algorithmic approach significantly enhances the reliability and precision of Doppler velocity estimation, contributing to the advancement of meteorological data analysis and forecasting capabilities.

The proposed VRAD algorithm is designed to operate effectively on both phase-coded and non-phase-coded scans. No modifications to radar waveform generation or signal transmission hardware are required, as the algorithm leverages base IQ data already collected during standard WSR-88D operations. This flexibility allows VRAD to be applied to a wide range of scanning strategies, including those used in both clear-air and precipitation modes.

### II. ALGORITHM DESCRIPTION AND IMPLEMENTATION

Two techniques are developed to improve the dealiasing and recovery of Doppler velocity estimates. The dealiasing technique draws from principles used in both the SPRT and 2DVDA algorithms. The recovery technique uses likely aliased CS velocity estimates to recover otherwise obscured velocities in the CD scan. A boundary condition that ensures a continuous velocity transition from the valid CD estimates to the potentially aliased CS estimates in the RF region is applied to determine the number of folds (to add or subtract multiples of 2vₐ) and to dealias the CS velocities. Then, velocities recovered from the CS scan are used to fill in the obscured regions in the field of velocities derived from the CD scan.

### A. Dealiasing

When Doppler velocity measurements exceed the maximum unambiguous velocity, aliasing occurs and apparent velocities are incorrect. This can be expressed by:

$${v}_{r} = {v}_{T} \pm 2 {kv}_{a} , \qquad ( 3 )$$

where vᵣ is the measured apparent Doppler velocity, vᵣ is the true Doppler velocity, and k is an integer that represents the number of times velocities were aliased in the Nyquist interval (2vₐ). Given the different PRTs used in the CS and CD scans, aliasing velocities for these scans are different. These can be calculated with (1), and will be defined as vₐ₁ for the CS, vₐ₂ for the CD, and naturally vₐ₂>vₐ₁.

The proposed dealiasing algorithm is implemented as a two-stage process. The first stage leverages the different unambiguous velocities resulting from different PRTs, and follows an approach used in the SPRT algorithm. The second stage leverages the spatial continuity of Doppler velocity measurements and uses a two-dimensional median filter. The stages are described next.

### 1) Velocity Difference Dealiasing

The difference between Doppler velocity measurements produces a characteristic curve that can be used to estimate dealiased velocities. This dealiasing scheme is similar to that described in the SPRT algorithm.

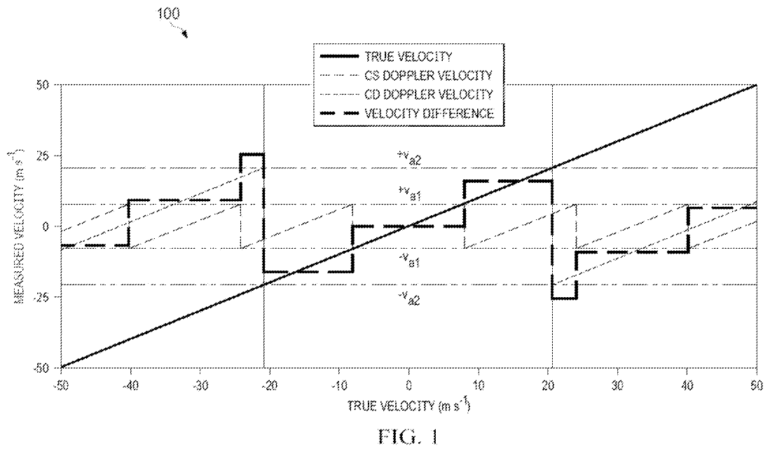

FIG. 1 is a graph 100 showing Doppler velocities that would be measured with typical CS and CD scan parameters. The long-dashed curve and the short-dashed curve respectively show the CS and CD Doppler velocities, corresponding dotted horizontal lines indicate the va₁ and va₂ boundaries, the solid line is the true velocity, and the thick-dashed curve is the difference in velocities, CD-CS, where parts of constant differences at different levels can be seen. These differences are used to estimate which velocity is correct. For this case, the dealiasing rules based on the characteristic velocity difference (v_{d}=vᵣ₂−vᵣ₁) are (see different regions in FIG. 1):

### Rule 1:

$$- {v}_{a 1} - ε \leq {v}_{d} < - {v}_{a 1} + ε , then {v}_{T} = {v}_{r 2} - 2 {v}_{a 2} ,$$

$${v}_{a 1} - ε \leq {v}_{d} < {v}_{a 1} + ε , then {v}_{T} = {v}_{r 2} - 2 {v}_{a 2} , or$$

$${v}_{d} > {v}_{a 2} - ε , then {v}_{T} = {v}_{r 2} - 2 {v}_{a 2}$$

### Rule 2:

$$- 2 {v}_{a 1} - ε \leq {v}_{d} < - 2 {v}_{a 1} + ε , then {v}_{T} = {v}_{r 2} ,$$

$$- ε \leq {v}_{d} < ε , then {v}_{T} = {v}_{r 2} , or$$

$$2 {v}_{a 1} - ε \leq {v}_{d} < 2 {v}_{a 1} + ε , then {v}_{T} = {v}_{r 2}$$

### Rule 3:

$${v}_{d} < - {v}_{a 2} + ε , then {v}_{T} = {v}_{r 2} + 2 {v}_{a 2} ,$$

$$- {v}_{a 1} - ε \leq {v}_{d} < - {v}_{a 1} + ε , then {v}_{T} = {v}_{r 2} + 2 {v}_{a 2} , or$$

$${v}_{a 1} - ε \leq {v}_{d} < {v}_{a 1} + ε , then {v}_{T} = {v}_{r 2} + 2 {v}_{a 2} .$$

vᵣ₁ and vᵣ₂ are the measured velocities in the CS and CD scans, and ε is a parameter to extend the range of velocities satisfying each rule. ε may be needed because in practice Doppler velocity measurements exhibit unavoidable estimation errors, and thus ideal identities are ineffective. Previous research on SPRT provides expressions to calculate an optimal ε, although these are not implemented in the proposed VRAD algorithm. In the VRAD algorithm, a value of 0.25vₐ₁ is adopted, which is sufficient to produce adequately-large regions of correctly-dealiased velocities such that the next step in the dealiasing process can correct the remaining estimates. Another dealiasing technique, robust to “catastrophic errors” that can result from the SPRT algorithm, is also applied.

### 2) Median Filter Dealiasing

The second stage implements a velocity dealiasing methodology based on a two-dimensional median filter, and it is based on 2DVDA. The core principle behind this dealiasing technique involves leveraging the spatial continuity of Doppler velocity measurements to identify and adjust values that are likely aliased. By comparing each velocity estimate against a dynamically calculated median value within a defined neighborhood, the algorithm identifies aliased velocities. If the difference between the velocity estimate under question and the local median velocity is greater than a set threshold, it is deemed as aliased. When an aliased velocity is found, multiples of 2vₐ (e.g., ±2, 4, 6vₐ) are added to it and compared against the local median. Then, the value that results in the lowest difference against the local median is selected. This approach not only enhances the accuracy of velocity data by mitigating aliasing errors but also maintains the integrity of the original data structure, ensuring that corrected velocities remain consistent with surrounding measurements.

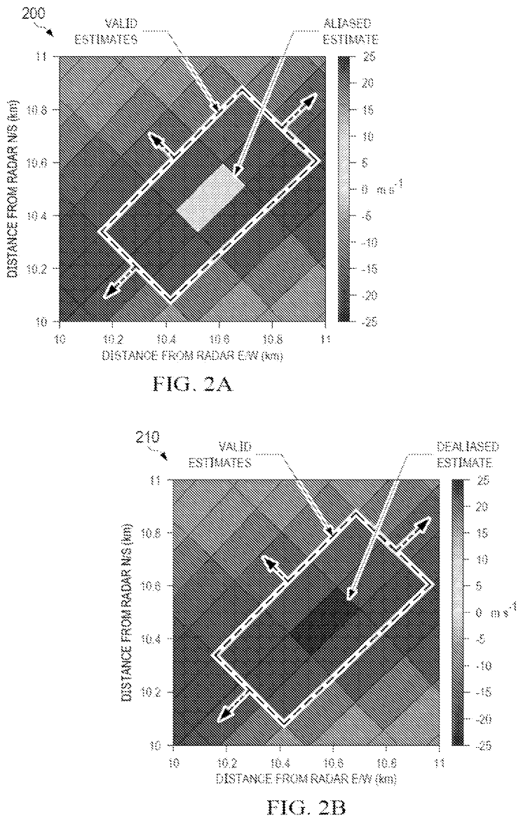

FIGS. 2A and 2B are graphs 200, 210 demonstrating the median filter dealiasing concept. FIG. 2A has an has an aliased velocity prior to the application of the filter. FIG. 2B shows the dealiased velocity. The dashed line represents the boundaries of the filter, in this case a 3×3 local neighborhood, and the arrows indicate the filter is a running window that moves across the entire Doppler velocity field. A single aliased velocity is found in the running window. The median filter then dealiases by subtracting 2vₐ.

The performance of this dealiasing technique depends on the size of the running window. For larger areas with aliased velocities, larger running windows are needed. And since the size of the region with aliased velocities depends on the type of precipitation system (e.g., small in a supercell and large in a hurricane), the median-filter dealiasing technique is applied multiple times with different window sizes. That ensures robustness to different type of storms, although it is more computationally expensive.

### B. Velocity Recovery

An echo recovery technique can provide major value to operational meteorologists, in particular, to the US NWS forecasters. These regions are often referred to as RF in WSR-88D data displays and documentation. However, this term is a misnomer. The affected velocity gates are not mislocated in range but rather contain overlaid signals from multiple range intervals due to extended propagation beyond the maximum unambiguous range. This disclosure retains the term “RF” for consistency with NEXRAD interface control documents and operational terminology, but VRAD should be understood to refer to regions with range-overlaid returns. VRAD can be applied in the split-cut scans and also in the batch scans. VRAD comprises using the likely aliased CS scan velocities (due to low vₐ) to fill in velocities in CD regions deemed as range folded (the so-called “purple haze” in radar data displays) and recover more Doppler velocity estimates.

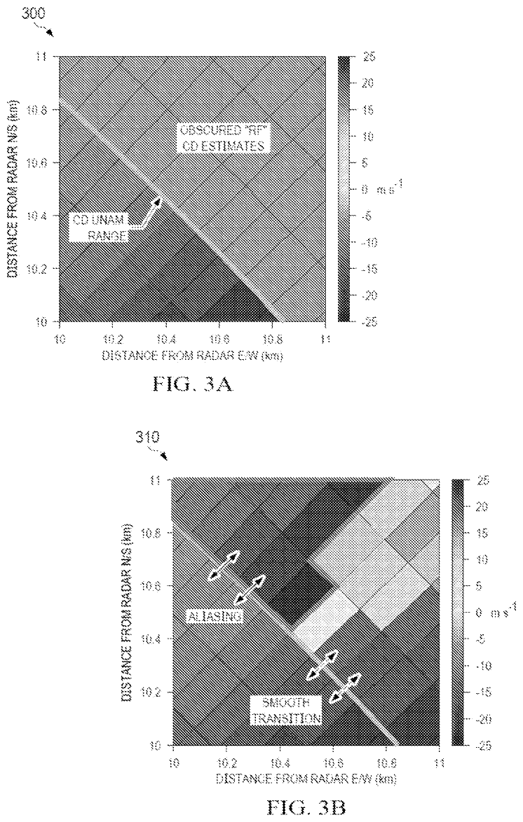

FIGS. 3A and 3B are graphs 300, 310 showing the conceptual depiction of the velocity recovery technique. FIG. 3A shows a field of CD velocities that has regions with obscured returns past the unambiguous range boundary and deemed RF. Then, CS velocities from those regions are extracted and used to create a hybrid CS/CD field of Doppler velocities. This use of Doppler velocities from the CS scan to recover obscured CD-scan velocity estimates represents a novel approach not currently employed in operational radar systems. While CS reflectivity is routinely used for range unfolding in the WSR-88D system, CS Doppler velocities are not used in any operational capacity due to their susceptibility to aliasing. The algorithm disclosed herein leverages these otherwise discarded CS velocities to extend valid Doppler coverage, demonstrating a unique and innovative use of redundant data collected during standard scanning procedures. FIG. 3B shows the field of valid CD velocities with the obscured RF region filled in with potentially aliased CS velocities. Then, a one-dimensional dealiasing function is applied across the CS/CD boundaries considering the CD estimates as correct (i.e., dealiased). The linear dealiasing function is defined as follows:

$${v}_{u} = {v}_{r 2} + 2 {pv}_{a 1} , \qquad ( 4 )$$

where vᵤ is the dealiased CS velocity and p is an integer. As done before for the median filter dealiasing, p is the integer that minimizes the difference between vᵤ and vᵣ₂. The key assumption is that the transition should result in a smooth field of Doppler velocities, expected from the physics of an atmospheric precipitation system. The linear dealiasing is applied following a spiral pattern in the CS-filled velocity regions, starting from the boundary between the CS and CD data and moving inwards. If a velocity estimate extracted from the CS scan and placed in an RF region does not have a neighbor with a valid CD velocity (i.e., outer edge of precipitation system), the function skips that sample. As the function iterates over the region, skipped samples are eventually reached. This CS-velocity dealiasing could be implemented in several ways, but following a spiral pattern may be the most robust method.

### C. Dealiasing and Recovery Algorithm

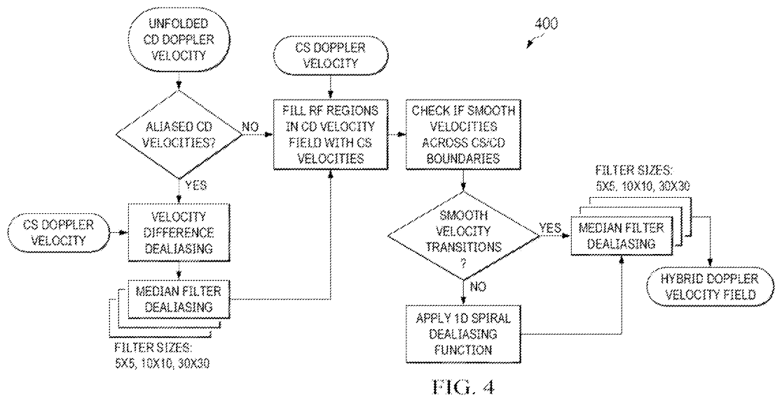

FIG. 4 is a flowchart of the VRAD algorithm 400. The VRAD algorithm 400 combines the described techniques as building blocks. First, the unfolded field of CD Doppler velocities is passed as an input, and instances for velocity aliasing are checked. If velocity aliasing is present, then the velocity difference and median filter dealiasing techniques described are applied. For the median filter dealiasing, three window sizes of 5×5, 10×10, and 30×30 are used. The smaller windows correct speckle-like aliased velocities, and the larger windows correct larger regions of aliased velocities. Filter sizes are adjustable parameters that can be changed for systems with potentially different aliased-velocity regions. After the dealiasing steps or if no velocity aliasing was present, the RF regions in the CD velocity field are filled with CS velocities. Then, CS/CD velocity transitions are checked for smoothness. In the current implementation, a threshold of 5 ms⁻¹ is used to determine if the transition is smooth or not. That is, if the velocity difference from a CD gate to a CS gate is less than 5 ms⁻¹, it is considered smooth or non-aliased. If the difference is greater or equal to 5 ms⁻¹, it is considered aliased. This parameter was chosen based on current cases evaluated; however, it can be changed to optimize algorithm performance. The linear dealiasing function is applied on regions with non-smooth transitions following a spiral pattern. Lastly, the median filter dealiasing technique is applied to the hybrid Doppler velocity field to ensure no other instance of velocity aliasing is present.

The VRAD algorithm is well suited for implementation on modern radar processing hardware. Although the current implementation described herein processes archived time-series or base moment data offline, the algorithmic steps, including velocity difference calculation, median filtering, and the 1D dealiasing spiral, can be readily implemented using DSPs, FPGAs, or general-purpose CPUs within the radar's backend. For instance, the algorithm could be integrated at the RPG level in the WSR-88D architecture, provided the CS velocities are made available. This opens the possibility for real-time or near-real-time execution of VRAD to enhance operational radar data products.

### III. EXPERIMENTAL DEMONSTRATION

The proposed algorithm is demonstrated by processing time-series IQ data from WSR-88D systems using both the operational and VRAD velocity estimators. Herein, we present the results for three relevant cases: one case from a non-phase-coded scan and two cases from phase-coded scans.

### A. Non-Phase-Coded Scan

Non-phase-coded scans are defined here as those in which neither the CS nor CD scans have pulse-to-pulse phase coding applied. That is, the CS and CD scan are collected with non-phase coded pulse sequences at constant PRTs. These are typically used in clear-air mode and for relatively weak precipitation events (e.g., snowstorms, ice storms) because they use a high number of pulses in the CD scan, which improves data quality.

On Dec. 13, 2020, a winter storm warning was issued covering most of north and central Oklahoma. Moderate to heavy snowfall blanketed parts of Oklahoma. Approximately 3 inches of snow accumulation were reported on average with some higher accumulations up to around 6 inches north and west of Oklahoma City. There were several power outages and road closures.

Time-series IQ data collected by the KCRI WSR-88D radar in Norman, Oklahoma at approximately 21:54:49 UTC were reprocessed to evaluate the VRAD algorithm. The radar was running the operational VCP 32, typical for widespread precipitation systems that produce overall weak SNR. The PRT used for the CS scan was 3.066 ms, and 67 samples were collected per dwell. The PRT used for the CD scan was 0.973 ms, and 227 samples were collected per dwell. With this, the CS and CD maximum unambiguous velocities are vₐ₁=9.03 ms⁻¹ and vₐ₂=28.47 ms⁻¹.

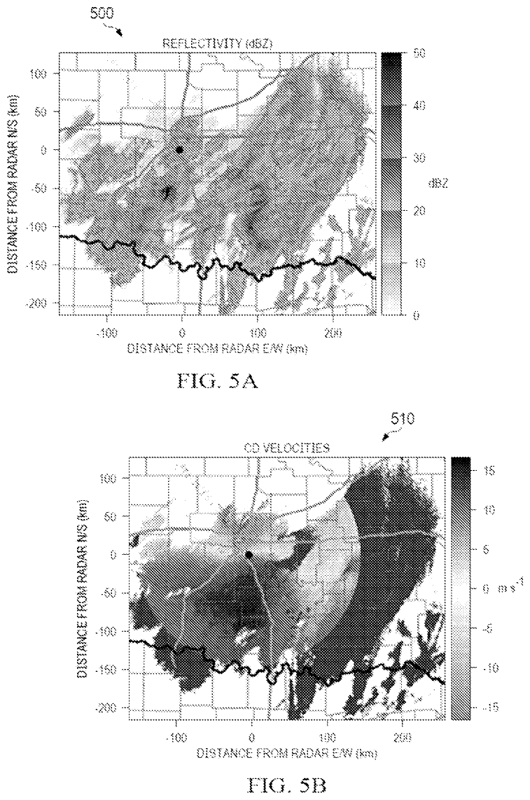

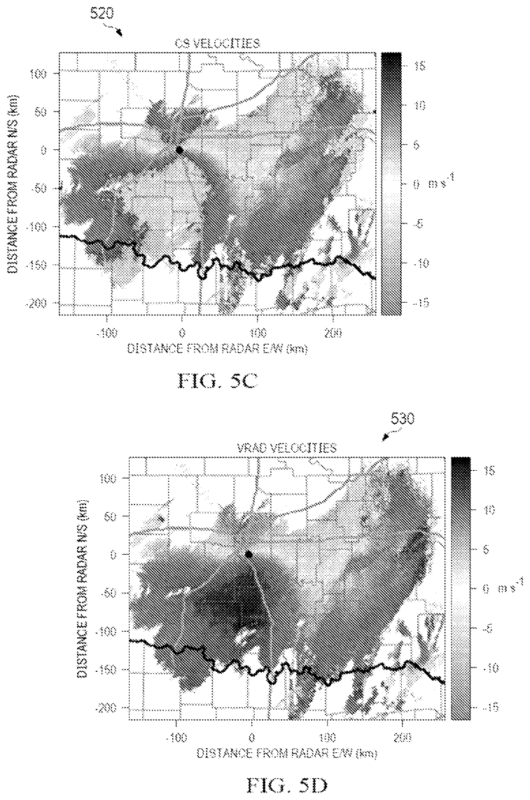

FIGS. 5A-5D are graphs 500, 510, 520, 530 showing processed fields of radar data. The radar data are from a snowstorm event in Oklahoma on Dec. 13, 2020, observed by the KCRI WSR-88D radar at approximately 21:54:49 UTC The black dot near the middle represents the radar location. Black contours represent the state lines, light-gray contours represent county lines, and dark-gray contours represent major highways. FIG. 5A shows the radar reflectivity field for reference to provide storm context. FIG. 5B shows the field of velocity estimates currently provided by the WSR-88D. Large RF regions shown in black are present to the southwest and east of the radar, where velocity estimates are overlaid from the first and second trips of the CD pulses. FIG. 5C shows the CS velocity field, where evidence of velocity aliasing is more evidently present to the north and south of the radar and also near the outer edges of the storm. FIG. 5D shows VRAD velocities.

After applying the VRAD algorithm, the velocity estimates in FIG. 5D are produced. Since there were no aliased velocities in the CD scan, the initial velocity difference and median filter dealiasing were not needed. A smooth transition past the unambiguous range of the CD scan is observed, where changes in the field of Doppler velocity across the boundary are less than 5 ms⁻¹.

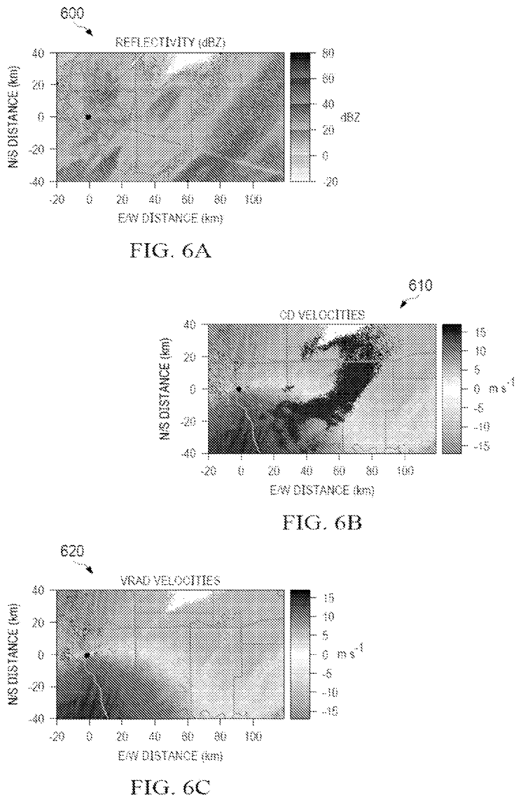

FIGS. 6A-6C are graphs 600, 610, 620 that are the same case as the graphs 500, 510, and 530 in FIGS. 5A, 5B, and 5D, but zoomed into the RF region east of the radar. FIGS. 6A-6C show the RF region is completely recovered by the VRAD algorithm, which provides a smooth field of Doppler velocities. A total of 103,940 range gates were recovered, which represents 26.55% of the valid meteorological returns in this case. Velocity data covering an area of approximately 38,000 km² were recovered.

### B. Phase-Coded Scans

Volume coverage patterns with phase-coded scans are typically used in convective precipitation modes. Phase coding the transmit pulses provides an effective method to resolve range-velocity. In the SZ-2 phase coding technique operational in the NEXRADs, transmitted pulses are phase shifted according to a sequence referred to as the switching code. The received echo samples are multiplied by the conjugate of the switching code sequence to remove the phases of transmit pulses artificially imposed by the switching code. Consequently, the first trip signals are made coherent and second (or higher order) trip signals are phase modulated. In general, any one of the overlaid trip signals can be cohered, leaving the rest modulated by different codes. This allows the recovery of Doppler velocity measurements beyond the theoretical maximum unambiguous range in the CD scan. Given the extended range of valid Doppler velocities recovered with phase-coded scans, these are used more regularly for observations of precipitation.

### 1) Hurricane Harvey

On Aug. 26, 2017, the devastating Hurricane Harvey made landfall on the coast of Houston, Texas. It was rated a category 4 hurricane in the Saffir-Simpson scale, indicating that the 1-minute maximum sustained winds were in the range from 58-70 ms⁻¹. These maximum wind speeds greatly exceed the typical maximum unambiguous velocities that weather radars can measure, therefore, aliasing would be expected. Harvey caused catastrophic flooding, more than 100 deaths, and major economic impacts to the region (estimated total damage at $125 billion). The resulting floods inundated hundreds of thousands of homes, which displaced more than 30,000 people and prompted more than 17,000 rescues. The storm also spawned approximately 53 tornadoes across six states.

Time-series IQ data from the operational KHGX observing Hurricane Harvey at approximately 02:17:36 UTC were acquired to evaluate the proposed VRAD algorithm. The radar was running the operational VCP 212, which uses a PRT of 3.1067 ms with 16 samples per dwell in the CS scan, and a PRT of 0.986 ms with 64 samples in the CD scan. These result in maximum unambiguous velocities of vₐ₁=8.92 ms⁻¹ and vₐ₂=28.08 ms⁻¹.

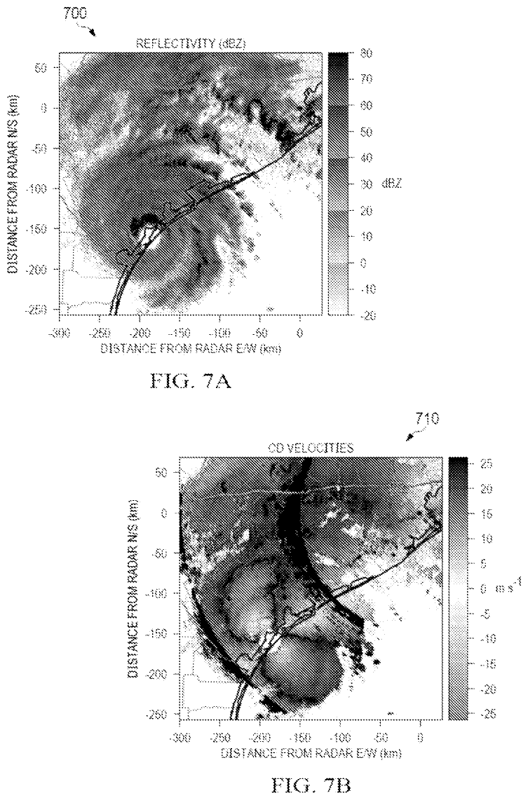

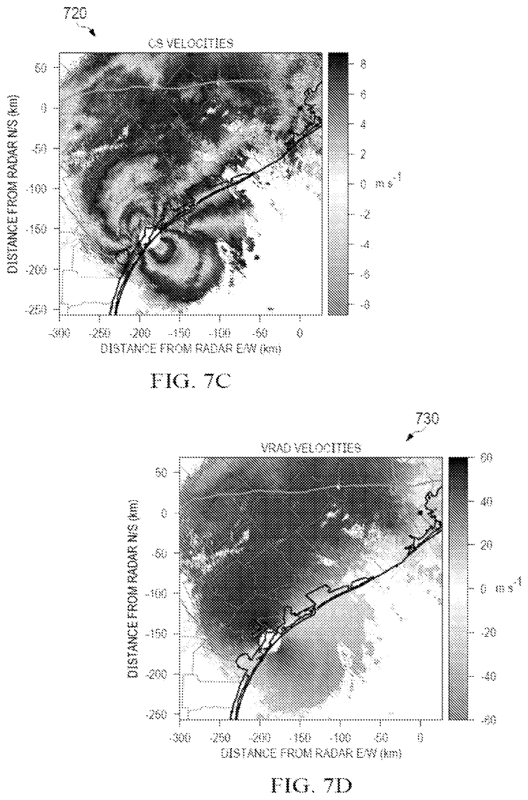

FIGS. 7A-7D are graphs 700, 710, 720, 730 of processed fields of radar data from Hurricane Harvey. The black dot near the top right represents the radar location. FIG. 7A shows the radar reflectivity field. FIG. 7B shows CD velocities produced by the WSR-88D real-time processing. It can be seen that the measurements around the eye of the hurricane are aliased and are entirely recovered by the SZ-2 processing algorithm from the second trip (i.e., past the maximum unambiguous range of the CD scan). Rings of RF-marked data are seen at ranges of approximately 150 km and 300 km. These correspond to range-folded returns that cannot be resolved by the SZ-2 algorithm, usually caused by strong ground clutter targets near the radar. FIG. 7C shows CS velocities, which are aliased several times due to the low vₐ₁. FIG. 7D shows velocities produced by the VRAD algorithm. In this case, the velocity difference and median filter dealiasing techniques were applied to the CD data before the velocity recovery technique. The field of velocities appears to be dealiased and does not show regions with RF echoes. That is, all censored velocity estimates were recovered using the CS scan data and the boundary conditions applied with the echo recovery technique. This is especially important in large and impactful precipitation systems like Hurricane Harvey because several potentially-tornadic circulations can span on the edges of the hurricane and be obscured by RF.

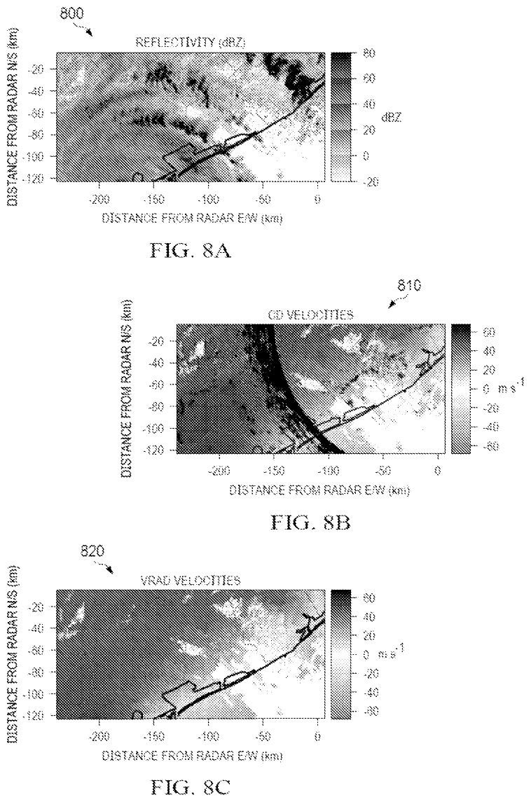

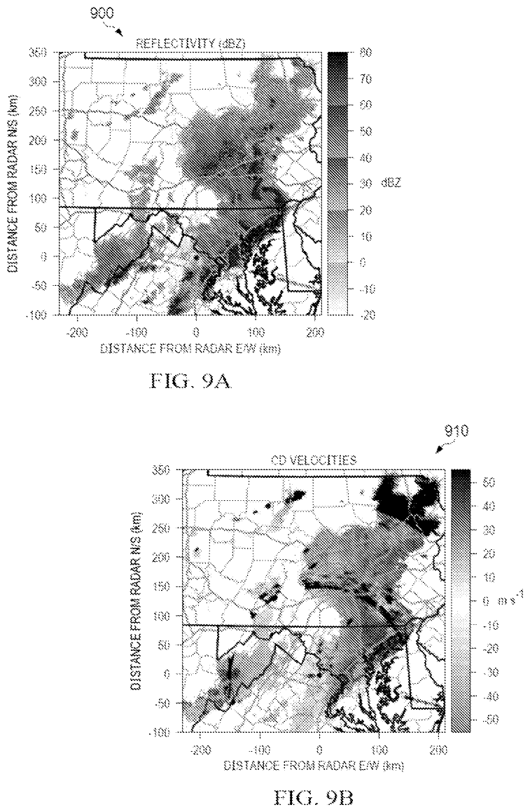

FIGS. 8A-8C are graphs 800, 810, 820 that are the same case as the graphs 700, 710, and 730 in FIGS. 7A, 7B, and 7D, but zoomed into the RF region east of the radar. In the VRAD field, it can be seen that the circle-shaped RF artifact created by ground clutter is mitigated and recovered values produce smooth velocities. A total of 45,645 range gates were recovered, which represents 10.24% of the valid meteorological returns. Velocity data covering an area of approximately 20,000 km² were recovered.

### 2) Severe Weather Outbreak

A severe weather outbreak took place on Aug. 7, 2023 across parts of the eastern U.S., stretching from Georgia to New York. Widespread and locally destructive damaging winds and tornadoes were the greatest threats. Millions of people were placed under tornado and severe thunderstorm watches as powerful thunderstorms brought flooding rain, hurricane-force wind gusts, large hail, and tornadoes in the evening hours. The storms left more than a million homes and businesses without power and grounded hundreds of flights. There were 16 confirmed tornadoes reported: 4 EF-0, 11 EF-1, 1 EF-2, and 1 EF-3. Two fatalities were reported.

Time-series IQ data from the operational KLWX in Sterling, Virginia observing the severe weather outbreak at approximately 22:06:21 UTC were acquired to evaluate the proposed VRAD algorithm. As in the previous case, the radar was running the operational VCP 212, which uses a PRT of 3.1067 ms with 16 samples per dwell in the CS scan, and a PRT of 0.986 ms with 64 samples in the CD scan. Since vₐ depends on the radar frequency, the maximum unambiguous velocities for this case are slightly different, vₐ₁=8.17 ms⁻¹ and vₐ₂=25.74 ms⁻¹.

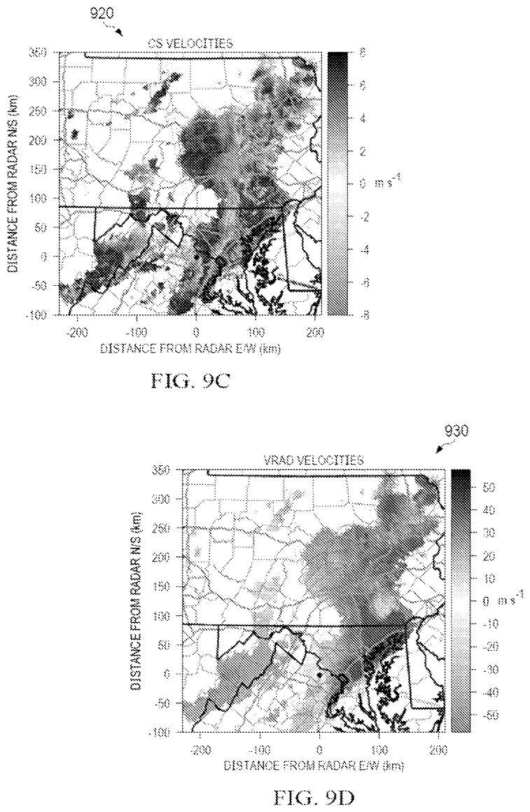

FIGS. 9A-9D are graphs 900, 910, 920, 930 of processed fields of radar data from the severe weather outbreak that devastated the North-East United States in August 2023. The black dot near the bottom represents the radar location. FIG. 9A shows the radar reflectivity field. FIG. 9B shows CD velocities produced. Evaluating the CD-scan velocities in FIG. 9B, it is apparent that storms were moving at high velocities, and some areas of aliasing to the east and west of the radar can be seen. In this case, velocity aliasing has some overlap on RF regions, which means that data from rapidly-evolving severe storms were obscured. At approximately 120 km east and 85 km north of the radar, a “bow echo” with a core of high Zₕ can be seen moving southwest to northeast. A broad circulation signature can be seen (i.e., light gray to white to black), obscured by a circle of range-folded returns. Severe thunderstorm warnings were in effect during this time, and NWS forecasters stated “Radar has indicated rotation within these severe thunderstorms. Although a tornado is not immediately likely, tornadoes can develop quickly during severe thunderstorms.” Forecasters and radar operators normally have the ability to select different PRTs to shift the circle of RF when it obscures important regions in the CD scan. However, in certain severe weather scenarios like this one, it is challenging to avoid range-folded returns on significant storm regions, since severe storms are widespread. In these cases, recovering velocities in the RF region is of critical importance. FIG. 9C shows CS velocities. FIG. 9D shows the field of velocity estimates produced by the VRAD algorithm. As in previous cases, it is apparent that the VRAD algorithm produced a smooth field of dealias velocities, mitigating RF regions. In addition to eliminating the circle of RF near the end of first trip signals, the VRAD algorithm recovers otherwise obscured velocities beyond the second trip. This can be seen in the top-right corner, approximately 300 km north and 200 km east of the radar.

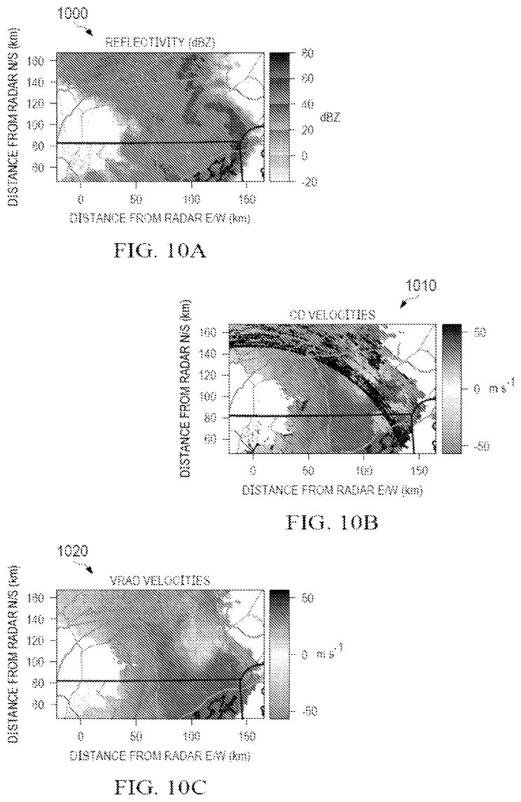

FIGS. 10A-10C are graphs 1000, 1010, 1020 that are the same case as the graphs 900, 910, and 930 in FIGS. 9A, 9B, and 9D, but zoomed into the RF region east of the radar. The most important observation is the recovery of velocities revealing a broad circulation, approximately 120 km north and 100 km east of the radar. The circulation is evidenced by the reduction in the values of outflow velocities (dark-gray tones), their transition to near-zero velocities (white tones) and even low inbound velocities (light-gray tones). This structure is consistent with the bow echo observed in the Zₕ field. Additionally, this case was selected because it illustrates a case where the VRAD algorithm fails in correctly recovering all velocities. This can be seen near the bottom-right corner (80 km north, 140 km east), where the velocity transitions do not appear to be smooth (i.e., contrasting darker dark-gray tones). This happens due to the occurrence of velocity aliasing in the CD scan concurrent with the RF region, which makes correct recovery and dealiasing more challenging. Limitations of the algorithm will be discussed in section IV, and a metric for evaluating incorrectly-dealiased regions will be introduced. A total of 35,128 range gates were recovered, which represents 10.56% of the valid meteorological returns in this case. Velocity data covering an area of approximately 14,400 km² were recovered.

### IV. PERFORMANCE EVALUATION

The VRAD algorithm performance is evaluated processing a total of 10 cases and considering certain metrics. First, the total number of velocity estimates recovered is quantified. That is, the number of recovered RF-designated range gates is counted. Next, the total area of the RF regions is computed. Lastly, the number of range gates on which the algorithm fails is estimated. Failed velocity recoveries are those that exhibit a non-smooth transition to at least one of the neighboring estimates. A threshold of 5 ms⁻¹ is used, selected because it is approximately one-half of the average maximum unambiguous velocity in the CS scan.

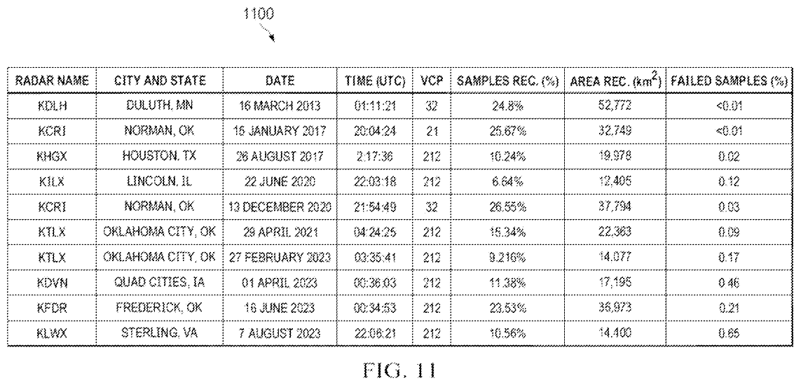

FIG. 11 is a table 1100 providing a VRAD algorithm performance summary. In the table 1100, evaluated cases are sorted in chronological order. As per the NEXRAD VCP naming convention, those with only two digits are non phase coded, and those with three digits have the phase coding technique applied to the CD scan. As expected, it can be seen that the relative number of gates recovered for the non-phase-coded scans is generally higher than with phase-coded scans. This is because the phase-coding technique recovers large regions of RF echoes, although it leaves circular-shaped artifacts on the data. The mean number of recover gates with non-phase-coded scans is 25.67% and with phase coded scans is 12.42%. The recovered areas (in km²) are provided as an absolute metric to quantify potential benefits of operational implementation of this technique. Lastly, it can be seen that the dealiasing failure for all cases is on average low, less than 1% of all significant meteorological returns. Higher failures are observed in cases with strong shear (aliasing in the CD scan), especially when it occurs around the RF regions. Some limitations of the proposed algorithm are discussed next.

The VRAD algorithm can bring important operational benefits to surveillance weather radars. However, some limitations need to be considered. First, dealiasing errors can result in large RF regions where CD-scan aliasing is also present. When aliasing occurs around RF regions, it is challenging to dealias velocities because there may not be spatial continuity and it may not be easy to discern true versus aliased velocities. This is a challenge for any dealiasing algorithm, and could be mitigated by improving the VRAD algorithm or using other dealiasing concepts. Moreover, this can be exacerbated in the echo recovery using the CS data, since CS-derived velocities may be aliased multiple times, especially if CD velocities are aliased. Next, the velocity difference dealiasing may not be effective for certain pairs of CS/CD PRTs currently used in operational VCPs, especially when PRTs are multiples of one another. That is, there are certain PRT ratios that result in more well-defined velocity differences and minimize dealiasing errors; this has been documented in previous SPRT research. This can be mitigated by making small adjustments to PRTs used to maintain the desired scan parameters while optimizing dealiasing performance. And although the velocity difference dealiasing technique is effective in the VRAD algorithm (which uses median filtering afterwards), it may be detrimental in cases of fast advecting storms at close ranges. This is because of the time difference between the CS and CD scans (usually in the order of 20 s). Comparing their velocity fields directly when storms are moving fast (and at close ranges) may be ineffective. To mitigate this, an additional check must be performed prior to the use of velocity difference dealiasing to evaluate if the velocity fields are in high agreement. This could be done using a simple spatial correlation filter on non-aliased velocity regions or after dealiasing. Lastly, although relatively modern processors can apply two-dimensional median filtering in real time, median calculation can be a computationally intensive operation. Thus, further investigation needs to be conducted to evaluate feasibility for real-time implementation of the VRAD algorithm as is. Alternatively, other efficient dealiasing techniques could be used, followed by the echo recovery technique.

The VRAD algorithm consistently demonstrates substantial recovery of Doppler velocity estimates that are otherwise censored or obscured in other processing. In several evaluated cases, over 25% of valid meteorological velocity estimates were recovered, representing areas as large as 38,000 km². These recovered fields offer more complete spatial continuity, which can directly support improved detection of mesocyclones, tornado signatures, and other hazardous wind phenomena. By extending the usable range of Doppler velocity observations, VRAD has the potential to enhance warning lead times and situational awareness for forecasters during rapidly-evolving weather events.

### V. CONCLUSION

The disclosed VRAD algorithm addresses the inherent range-velocity ambiguities present in multi-PRT scans used by weather radars. By leveraging the capabilities of both CS and CD scans, the algorithm significantly enhances the accuracy and spatial extent of valid Doppler velocity estimates, thereby improving the quality of meteorological observations.

The algorithm combines dealiasing techniques with a velocity recovery process that exploits the complementary strengths of CS and CD scans. It was demonstrated through experimental evaluations, including both non-phase-coded scans and phase-coded scans, that the VRAD algorithm is capable of recovering valid velocity estimates in areas previously obscured due to aliasing or the presence of RF signals. This improvement was quantified by a marked increase in the percentage of valid velocity estimates recovered across various weather events, including severe weather outbreaks and hurricanes.

Furthermore, the algorithm's ability to fill in obscured velocity regions with CS scan data while maintaining a smooth transition between CS and CD data is particularly noteworthy. This feature not only enhances the completeness and accuracy of the velocity fields, but also has the potential to provide meteorologists with more reliable data for forecasting and analysis, especially in the context of severe weather events.

While the VRAD algorithm demonstrates a significant advancement in dealing with the Doppler dilemma, there are limitations, including its performance in cases of strong shear or when aliasing occurs around RF regions. Future work may focus on refining the algorithm to address these challenges, exploring the optimization of PRT ratios, and investigating the feasibility of real-time implementation.

In conclusion, the VRAD algorithm represents a significant step forward in the ongoing effort to improve weather radar capabilities. By providing more accurate and extensive Doppler velocity estimates, this algorithm has the potential to enhance the understanding of atmospheric processes and improve weather forecasting accuracy. Further research and development will continue to refine and adapt this algorithm to meet the evolving needs of meteorological research and operational forecasting.

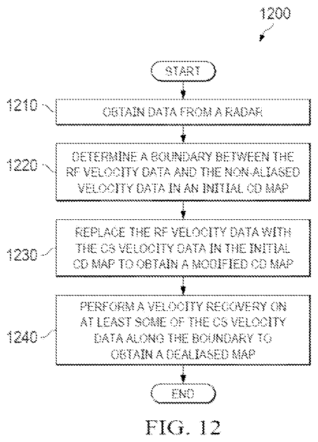

FIG. 12 is a flowchart illustrating a method 1200 of VRAD. At step 1210, data from a radar is obtained. The data comprise CD velocity data and CS velocity data. The CD velocity data comprise RF velocity data and unfolded velocity data, or non-aliased data. The CS velocity data are aliased and spatially correspond to regions with the RF velocity data. At step 1220, a boundary between the RF velocity data and the non-aliased velocity data in an initial CD map is determined. At step 1230, the RF velocity data are replaced with the CS velocity data in the initial CD map to obtain a modified CD map. At step 1240, a velocity recovery is performed on at least some of the CS velocity data along the boundary to obtain a dealiased map.

The method 1200 may implement additional embodiments as follows: The data are from a split-cut scan mode. The data are from a batch mode or a dual-PRF mode. The dual-PRF mode comprises two coherent trains of pulses transmitted in sequence with different pulse repetition frequencies. The CS velocity data are from a first scan. The CD velocity data are from a second scan. The RF data are obscured. The non-aliased velocity data are not obscured.

Performing the velocity recovery comprises determining, from among the CS velocity data, first CS velocity data that do not smoothly transition from first adjacent non-aliased velocity data that are of the non-aliased velocity data and that are adjacent to the first CS velocity data; and dealiasing the first CS velocity data to obtain dealiased CS velocity data. Dealiasing the first CS velocity data is based on the first adjacent non-aliased velocity data, the first CS velocity data, and a constant. The constant minimizes a difference between the dealiased CS velocity data and the first adjacent non-aliased velocity data. The constant is an integer. Performing the velocity recovery further comprises determining, from among the CS velocity data, second CS velocity data that smoothly transition from second adjacent non-aliased velocity data that are of the non-aliased velocity data and that are adjacent to the second CS velocity data; and preserving the second CS velocity data in the dealiased map. Performing the velocity recovery further comprises determining, from among the CS velocity data, third CS velocity data that do not have third adjacent non-aliased velocity data that are of the non-aliased velocity data and that are adjacent to the third CS velocity data; and preserving the third CS velocity data in the dealiased map.

The method 1200 further comprises performing the velocity recovery in a spiral pattern starting from the boundary and moving inwards within the CS velocity data. The boundary is based on a PRT. The method further comprises performing velocity difference dealiasing on the CS velocity data. The method further comprises performing the velocity difference dealiasing using a velocity difference curve, wherein the velocity difference curve is based on a difference between a CS velocity data curve and a CD velocity data curve.

The method further comprises performing median filter dealiasing on the CD velocity data or the CS velocity data. Performing the median filter dealiasing comprises determining a window of window data from among the CD velocity data or the CS velocity data; calculating a baseline value of the window data, wherein the baseline value is a median value or a mean value; determining, from among the window data, first window data that are far from the baseline value; and dealiasing the first window data. Dealiasing the first window data is based on the first window data, a Nyquist velocity, and a constant. The constant minimizes a standard deviation of the window data. Far from the baseline value means a deviation of more than 5 m/s.

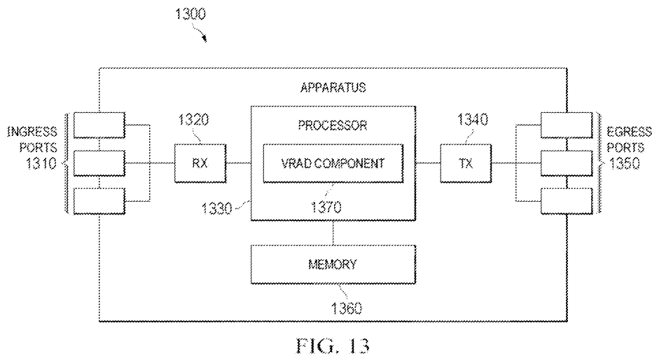

FIG. 13 is a schematic diagram of an apparatus 1300. The apparatus 1300 may implement the disclosed embodiments. The apparatus 1300 comprises ingress ports 1310 and an RX 1320 to receive data; a processor 1330, or logic unit, baseband unit, or CPU, to process the data; a TX 1340 and egress ports 1350 to transmit the data; and a memory 1360 to store the data. The apparatus 1300 may also comprise OE components, EO components, or RF components coupled to the ingress ports 1310, the RX 1320, the TX 1340, and the egress ports 1350 to provide ingress or egress of optical signals, electrical signals, or RF signals.

The processor 1330 is any combination of hardware, middleware, firmware, or software. The processor 1330 comprises any combination of one or more CPU chips, cores, FPGAS, ASICs, or DSPs. The processor 1330 communicates with the ingress ports 1310, the RX 1320, the TX 1340, the egress ports 1350, and the memory 1360. The processor 1330 comprises a VRAD component 1370, which implements the disclosed embodiments. The inclusion of the VRAD component 1370 therefore provides a substantial improvement to the functionality of the apparatus 1300 and effects a transformation of the apparatus 1300 to a different state. Alternatively, the memory 1360 stores the VRAD component 1370 as instructions, and the processor 1330 executes those instructions.

The memory 1360 comprises any combination of disks, tape drives, or solid-state drives. The apparatus 1300 may use the memory 1360 as an overflow data storage device to store programs when the apparatus 1300 selects those programs for execution and to store instructions and data that the apparatus 1300 reads during execution of those programs. The memory 1360 may be volatile or non-volatile and may be any combination of ROM, RAM, TCAM, or SRAM.

A computer program product may comprise computer-executable instructions that are stored on a computer-readable medium and that, when executed by a processor, cause an apparatus to perform any of the embodiments. The non-transitory medium may be the memory 1360, the processor may be the processor 1330, and the apparatus may be the apparatus 1300.

A first embodiment relates to a method comprising: obtaining data from a radar, wherein the data comprise CD velocity data and CS velocity data, wherein the CD velocity data comprise RF velocity data and non-aliased velocity data, and wherein the CS velocity data are aliased and spatially correspond to regions with the RF velocity data; determining a boundary between the RF velocity data and the non-aliased velocity data in an initial CD map; replacing the RF velocity data with the CS velocity data in the initial CD map to obtain a modified CD map; and performing a velocity recovery on at least some of the CS velocity data along the boundary to obtain a dealiased map.

In a first implementation of the first embodiment, the data are from a split-cut scan mode, a batch mode, or a dual-PRF mode, and the dual-PRF mode comprises two coherent trains of pulses transmitted in sequence with different pulse repetition frequencies.

In a second implementation of the first embodiment or any preceding implementation of the first embodiment, the CS velocity data are from a first scan, and the CD velocity data are from a second scan.

In a third implementation of the first embodiment or any preceding implementation of the first embodiment, the RF data are obscured, and the non-aliased velocity data are not obscured.

In a fourth implementation of the first embodiment or any preceding implementation of the first embodiment, performing the velocity recovery comprises: determining, from among the CS velocity data, first CS velocity data that do not smoothly transition from first adjacent non-aliased velocity data that are of the non-aliased velocity data and that are adjacent to the first CS velocity data; and dealiasing the first CS velocity data to obtain dealiased CS velocity data.

In a sixth implementation of the first embodiment or any preceding implementation of the first embodiment, dealiasing the first CS velocity data is based on the first adjacent non-aliased velocity data, the first CS velocity data, and a constant.

In a seventh implementation of the first embodiment or any preceding implementation of the first embodiment, the constant minimizes a difference between the dealiased CS velocity data and the first adjacent non-aliased velocity data.

In an eighth implementation of the first embodiment or any preceding implementation of the first embodiment, performing the velocity recovery further comprises: determining, from among the CS velocity data, second CS velocity data that smoothly transition from second adjacent non-aliased velocity data that are of the non-aliased velocity data and that are adjacent to the second CS velocity data; and preserving the second CS velocity data in the dealiased map.

In a ninth implementation of the first embodiment or any preceding implementation of the first embodiment, performing the velocity recovery further comprises: determining, from among the CS velocity data, third CS velocity data that do not have third adjacent non-aliased velocity data that are of the non-aliased velocity data and that are adjacent to the third CS velocity data; and preserving the third CS velocity data in the dealiased map.

In a tenth implementation of the first embodiment or any preceding implementation of the first embodiment, the method further performing the velocity recovery in a spiral pattern starting from the boundary and moving inwards within the CS velocity data.

In an eleventh implementation of the first embodiment or any preceding implementation of the first embodiment, the boundary is based on a PRT.

In a twelfth implementation of the first embodiment or any preceding implementation of the first embodiment, the method further comprises performing velocity difference dealiasing on the CS velocity data.

In a thirteenth implementation of the first embodiment or any preceding implementation of the first embodiment, the method further comprises further performing the velocity difference dealiasing using a velocity difference curve, wherein the velocity difference curve is based on a difference between a CS velocity data curve and a CD velocity data curve.

In a fourteenth implementation of the first embodiment or any preceding implementation of the first embodiment, the method further comprises performing median filter dealiasing on the CD velocity data or the CS velocity data.

In a fifteenth implementation of the first embodiment or any preceding implementation of the first embodiment, performing the median filter dealiasing comprises: determining a window of window data from among the CD velocity data or the CS velocity data; calculating a baseline value of the window data, wherein the baseline value is a median value or a mean value; determining, from among the window data, first window data that are far from the baseline value; and dealiasing the first window data.

In a sixteenth implementation of the first embodiment or any preceding implementation of the first embodiment, dealiasing the first window data is based on the first window data, a Nyquist velocity, and a constant.

In a seventeenth implementation of the first embodiment or any preceding implementation of the first embodiment, the constant minimizes a standard deviation of the window data.

In an eighteenth implementation of the first embodiment or any preceding implementation of the first embodiment, far from the baseline value means a deviation of more than 5 m/s.

In a second embodiment, an apparatus comprises: a memory configured to store instructions; and one or more processors coupled to the memory and configured to execute the instructions to cause the apparatus to: obtain data from a radar, wherein the data comprise CD velocity data and CS velocity data, wherein the CD velocity data comprise RF velocity data and non-aliased velocity data, and wherein the CS velocity data are aliased and spatially correspond to regions with the RF velocity data; determine a boundary between the RF velocity data and the non-aliased velocity data in an initial CD map; replace the RF velocity data with the CS velocity data in the initial CD map to obtain a modified CD map; and perform a velocity recovery on at least some of the CS velocity data along the boundary to obtain a dealiased map. The second embodiment may implement any preceding implementation of the first embodiment.

In a third embodiment, a computer program product comprises instructions that are stored on a computer-readable medium and that, when executed by one or more processors, cause an apparatus to: obtain data from a radar, wherein the data comprise CD velocity data and CS velocity data, wherein the CD velocity data comprise RF velocity data and non-aliased velocity data, and wherein the CS velocity data are aliased and spatially correspond to regions with the RF velocity data; determine a boundary between the RF velocity data and the non-aliased velocity data in an initial CD map; replace the RF velocity data with the CS velocity data in the initial CD map to obtain a modified CD map; and perform a velocity recovery on at least some of the CS velocity data along the boundary to obtain a dealiased map. The third embodiment may implement any preceding implementation of the first embodiment.

The term “about” means a range including ±10% of the subsequent number unless otherwise stated. Where single components, apparatuses, or systems are described as performing functions, multiple such components, apparatuses, or systems may implement the functions.

While several embodiments have been provided, the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented. Likewise, where single components, apparatuses, or systems are described as performing functions, multiple such components, apparatuses, or systems may implement the functions.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method comprising:
obtaining data from a radar, wherein the data comprise continuous Doppler (CD) velocity data and continuous surveillance (CS) velocity data, wherein the CD velocity data comprise range-folded (RF) velocity data and non-aliased velocity data, and wherein the CS velocity data are aliased and spatially correspond to regions with the RF velocity data;
determining a boundary between the RF velocity data and the non-aliased velocity data in an initial CD map;
replacing the RF velocity data with the CS velocity data in the initial CD map to obtain a modified CD map; and
performing a velocity recovery on at least some of the CS velocity data along the boundary to obtain a dealiased map.

2. The method of claim 1, wherein the data are from a split-cut scan mode, a batch mode, or a dual-pulse repetition frequency (PRF) mode, and wherein the dual-PRF mode comprises two coherent trains of pulses transmitted in sequence with different pulse repetition frequencies.

3. The method of claim 1, wherein the CS velocity data are from a first scan, and wherein the CD velocity data are from a second scan.

4. The method of claim 1, wherein the RF data are obscured, and wherein the non-aliased velocity data are not obscured.

5. The method of claim 1, wherein performing the velocity recovery comprises:
determining, from among the CS velocity data, first CS velocity data that do not smoothly transition from first adjacent non-aliased velocity data that are of the non-aliased velocity data and that are adjacent to the first CS velocity data; and
dealiasing the first CS velocity data to obtain dealiased CS velocity data.

6. The method of claim 5, wherein dealiasing the first CS velocity data is based on the first adjacent non-aliased velocity data, the first CS velocity data, and a constant.

7. The method of claim 6, wherein the constant minimizes a difference between the dealiased CS velocity data and the first adjacent non-aliased velocity data.

8. The method of claim 5, wherein performing the velocity recovery further comprises:
determining, from among the CS velocity data, second CS velocity data that smoothly transition from second adjacent non-aliased velocity data that are of the non-aliased velocity data and that are adjacent to the second CS velocity data; and
preserving the second CS velocity data in the dealiased map.

9. The method of claim 8, wherein performing the velocity recovery further comprises:
determining, from among the CS velocity data, third CS velocity data that do not have third adjacent non-aliased velocity data that are of the non-aliased velocity data and that are adjacent to the third CS velocity data; and
preserving the third CS velocity data in the dealiased map.

10. The method of claim 1, further comprising further performing the velocity recovery in a spiral pattern starting from the boundary and moving inwards within the CS velocity data.

11. The method of claim 1, wherein the boundary is based on a pulse repetition time (PRT).

12. The method of claim 1, further comprising performing velocity difference dealiasing on the CS velocity data.

13. The method of claim 12, further comprising further performing the velocity difference dealiasing using a velocity difference curve, wherein the velocity difference curve is based on a difference between a CS velocity data curve and a CD velocity data curve.

14. The method of claim 1, further comprising performing median filter dealiasing on the CD velocity data or the CS velocity data.

15. The method of claim 14, wherein performing the median filter dealiasing comprises:
determining a window of window data from among the CD velocity data or the CS velocity data;
calculating a baseline value of the window data, wherein the baseline value is a median value or a mean value;
determining, from among the window data, first window data that are far from the baseline value; and
dealiasing the first window data.

16. The method of claim 15, wherein dealiasing the first window data is based on the first window data, a Nyquist velocity, and a constant.

17. The method of claim 16, wherein the constant minimizes a standard deviation of the window data.

18. The method of claim 15, wherein far from the baseline value means a deviation of more than 5 meters per second (m/s).

19. An apparatus comprising:
a memory configured to store instructions; and
one or more processors coupled to the memory and configured to execute the instructions to cause the apparatus to:
obtain data from a radar, wherein the data comprise continuous Doppler (CD) velocity data and continuous surveillance (CS) velocity data, wherein the CD velocity data comprise range-folded (RF) velocity data and non-aliased velocity data, and wherein the CS velocity data are aliased and spatially correspond to regions with the RF velocity data;
determine a boundary between the RF velocity data and the non-aliased velocity data in an initial CD map;
replace the RF velocity data with the CS velocity data in the initial CD map to obtain a modified CD map; and
perform a velocity recovery on at least some of the CS velocity data along the boundary to obtain a dealiased map.

20. A computer program product comprising instructions that are stored on a computer-readable medium and that, when executed by one or more processors, cause an apparatus to:
obtain data from a radar, wherein the data comprise continuous Doppler (CD) velocity data and continuous surveillance (CS) velocity data, wherein the CD velocity data comprise range-folded (RF) velocity data and non-aliased velocity data, and wherein the CS velocity data are aliased and spatially correspond to regions with the RF velocity data;
determine a boundary between the RF velocity data and the non-aliased velocity data in an initial CD map;
replace the RF velocity data with the CS velocity data in the initial CD map to obtain a modified CD map; and
perform a velocity recovery on at least some of the CS velocity data along the boundary to obtain a dealiased map.
